(19) United States
(12) Patent Application Publication
(10) Pub. No.: US 2010/0142137 A1
(43) Pub. Date: Jun. 10, 2010

(54) Display screen mounting device and method

(76) Inventor: Kenneth Kwak, Venice, CA (US)

Correspondence Address: Cislo & Thomas LLP, 1333 2nd Street, Suite #500, Santa Monica, CA, 90401-4110, US

(21) Appl. No.: 12/316,146

(22) Filed: Dec. 10, 2008

(51) Int. Cl. G06F 1/16; B23P 11/00

(52) U.S. Cl. 361/679.05; 361/679.21; 29/428

(57) ABSTRACT

A support mount for a display screen such as a television or computer, comprises a length adjustable arm, which is recessed inside a wall. The system allows for the display screen to lay flatter and cleaner to the wall, and retract in and out. According to one embodiment, the arm includes a mounting element for the screen which allows for movement of the screen relative to the arm. According to a further embodiment, positioning of the screen may be electronically controlled.

### BACKGROUND

1. Field of the Invention

The present invention relates to a mounting device and method for mounting a display screen, such as an LCD TV and/or computer to a wall.

2. Description of the Related Art

There are various devices for mounting display screens such as LCD and Plasma flat panel television and/or computer. Such devices include various features which allow for flexibility in movement of the display screen, such as telescopic arms, and swivel and/or pivoting arm mechanisms. See for example Feldpausch et al., U.S. Pat. No. 6,739,096, which discloses a vertically oriented support device having a telescopic arm. However, as most users are typically concerned with visual aesthetics, space management, and neatness; it is desirable to provide a mounting device which is both physically and visually unobtrusive and uncluttered.

### SUMMARY

The present provides a support mount for a display screen such as a television or computer, comprising a length adjustable arm, which is recessed inside a wall. The system allows for the display screen to lay flatter and cleaner to the wall, and retract in and out. According to one embodiment, the arm allows for position adjustment of the screen which may be electronically controlled. According to a further embodiment, position adjustment may be electronically controlled.

### OBJECTS OF THE INVENTION

It is an object of the present invention to provide a device and method for mounting a display screen to a wall, wherein the mounting element may be substantially hidden from view.

It is another object of the present invention to provide such a device and method which enables the screen to optionally lie flat against the wall or extend away from the wall.

It is another object of the present invention to provide such a device and method which enables the position of the screen to be adjusted on the mounting device.

The foregoing objects are some of but a few of the goals sought to be attained by the present invention and are set forth for the purposes of example only and not those of limitation.

### BRIEF DESCRIPTION OF THE DRAWINGS

FIG. 1 is a side sectional view of a mounting device, according to a first embodiment including a telescoping arm and a recessed housing which fits within a wall recess, for mounting a display screen. The arm is illustrated in an extended position.

FIG. 2 illustrates the device of FIG. 1, wherein the recessed housing is omitted, and the extended arm is directly mounted to the wall recess, according to an alternate embodiment.

FIG. 3 illustrates the device of FIG. 1, wherein the arm is retracted, and the screen fits within the housing recess.

FIG. 4 illustrates the device of FIG. 1, wherein the housing recess is smaller than the screen, and only the arm, but not the screen, fits within the recess.

FIG. 5 illustrates the device of FIG. 1, wherein the arm is mounted within a recess of a wall, according to an alternate embodiment.

FIG. 6 is a perspective view of a telescopic arm for the device of FIG. 1.

FIG. 7 illustrates the device of FIG. 1, wherein the arm comprises a series of pivotally connected bars.

FIG. 8 is a perspective view of the device of FIG. 1, including an arm having a series of pivotally connected elements, in accordance with a preferred embodiment.

FIG. 9a is a side view of the device of FIG. 1, wherein arm includes pivotally connected links having an “X” configuration.

FIG. 9b is a plan view of the device of FIG. 9a, wherein the arm is folded into the housing.

FIG. 10a is a side view of the device of FIG. 1, wherein arm includes pivotally connected links having a triangularly configured portion.

FIG. 10b is a plan view of the device of FIG. 10a, wherein the arm is folded into the housing.

### DETAILED DESCRIPTION OF THE PREFERRED EMBODIMENT

The detailed description set forth below is intended as a description of exemplary embodiments and is not intended to represent the only forms in which the exemplary embodiments may be constructed and/or utilized. The description sets forth the functions and the sequence of steps for constructing and/or operating the exemplary embodiments. However, it is to be understood that the same or equivalent functions and sequences may be accomplished by different exemplary methods are also intended to be encompassed within the spirit and scope of the invention, and within the scope and judgment of the skilled person.

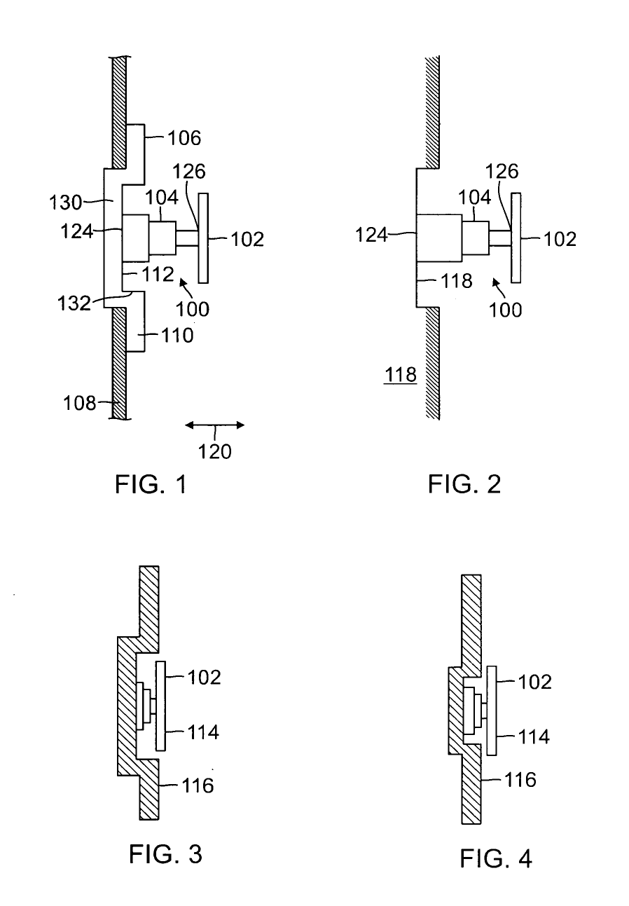

As illustrated in FIG. 1, the present invention provides a support mount device 100 for a display screen 102 such as a television or computer, which is ideally a flat display screen. The device comprises a length adjustable arm 104, supported in a housing 110 having a central recess 112 comprising a flat surface 130 and surrounding walls 132 extending from the surface and generally perpendicular thereto. Additionally, there is a frame 106 around the recess, extending from the side walls 132, generally perpendicular to the walls.

The housing is mounted to a wall 108. Assuming the thickness of the wall is less than the depth dimension 120 of the housing recess 112, a window may be carved into the wall, and the frame 106 of the housing 110 attached to the wall by any conventional method such as cementing, bolting, nailing, etc. The housing 110 may be made of metal, wood, plastic, or other suitable material, and combinations of different materials. According to a preferred embodiment, the housing is made of metal which is plastic coated. The housing frame 106 may be minimized, with a sheet thin depth dimension to make its appearance inconspicuous, or may be thicker, so as to provide a decorative frame around the screen.

in case where the wall is thick enough, a recess 118 may be carved within the wall, wherein the housing recess conforms to the wall recess 118, or the arm 104 may be mounted directly to the wall recess 118, as shown in FIG. 2.

The recess of the housing 110 and/or wall may be dimensioned to receive the screen 102, such that the surrounding wall or housing surface 116 frames the screen. Additionally, the arm 104 may allow for retraction of the screen 102 back enough into the recess, such that the surface 116 may be substantially flush with the screen surface 114, as illustrated in FIG. 3 for a device having a housing 110, or may be able to back even further into the wall depending on the depth dimension of the recess.

Alternatively, the recess may be narrower than the screen, allowing the screen to lie flat against the wall or housing frame, but not insert into the recess, as illustrated in FIG. 4.

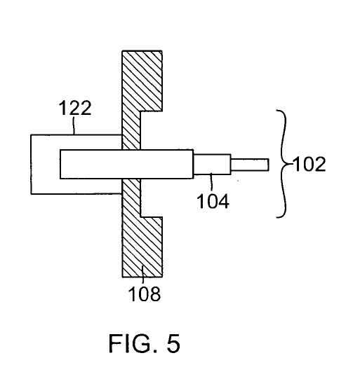

The arm 104, which is illustrated in FIGS. 1-4, has a series of telescopically engaged elements, making it extendable/retractable. Its first end 124 may be integrally formed with or firmly mounted to the housing 110 and/or wall by any conventional means, including bolting, soldering, cementing, etc. depending on the material(s) of the device 100. It is also possible to mount the arm 104 within a recess 122 of a wall 108 having sufficient depth, in order to provide extra support for the screen, as illustrated in FIG. 5. According to this embodiment, the housing itself may include the recess 122, or a bore may be made through the housing, and the arm may extend into the wall by itself.

The second end 126 of the arm also includes a mounting element for attachment to the screen, or to a mounting element in the back of the screen. Instead of providing for a fixed mounting mechanism, mounting elements at either or both ends 124 and 126 may allow for movement such as swivel, pivotal, up and down, side-to-side, or combinations thereof. Additional mounting components, i.e. brackets, mounting adaptors, plates, etc., may be provided for attachment of the screen.

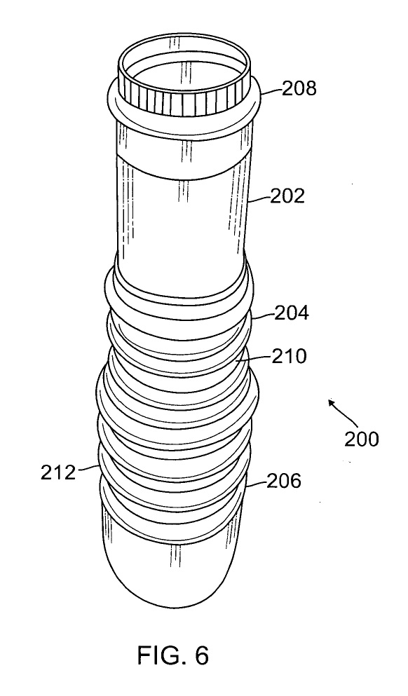

A telescopic arm 200 is illustrated in FIG. 6, and includes a series of telescopically engageable cylindrical units 202, 204, and 206. Outwardly protruding rings 208, 210, 212 on each of the units provides length adjustable of each unit to the adjacent unit.

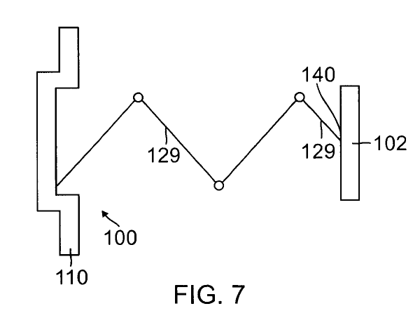

Other examples of suitable arms which are extendable/retractable include a series of pivotally connected elements such as links or bars 129 supporting a mounting element 140 for a screen, as illustrated in FIGS. 7, 8, 9a and b, and 10a and b.

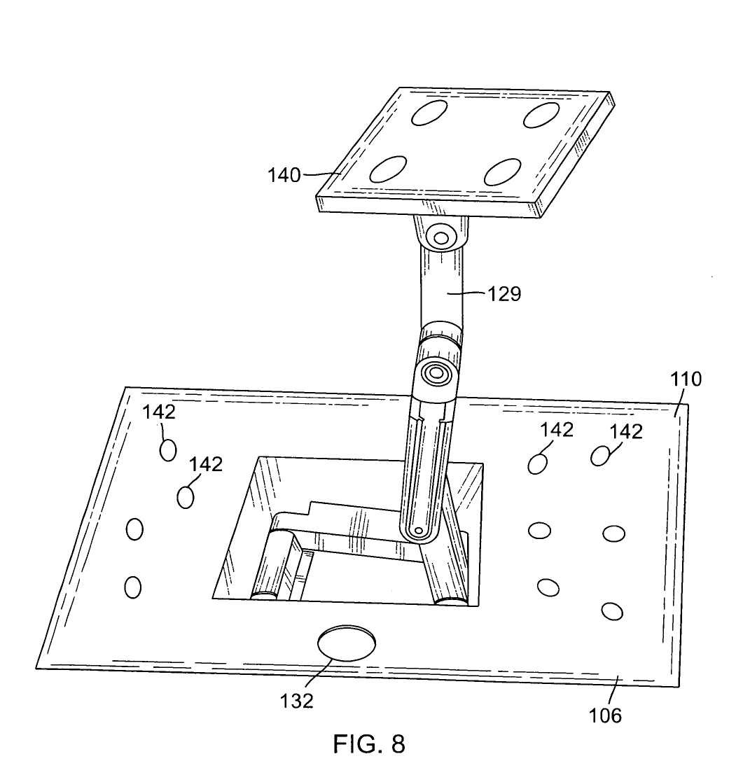

Also, as illustrated in FIG. 8, the device 100 includes a hole 132, or cut out section, provided in the surface 116 of the housing 110, for receiving the wires of the screen. A conduit may also be provided behind the hole to contain the wires. The frame 106 of the housing 110 includes slits 142 through which screws can be inserted for attachment to a wall.

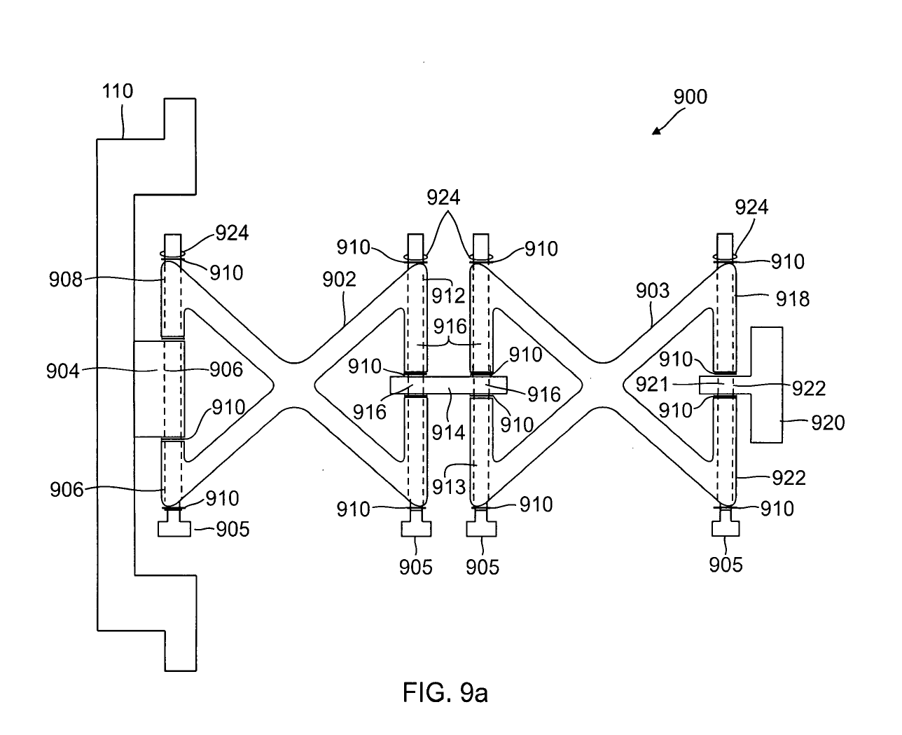

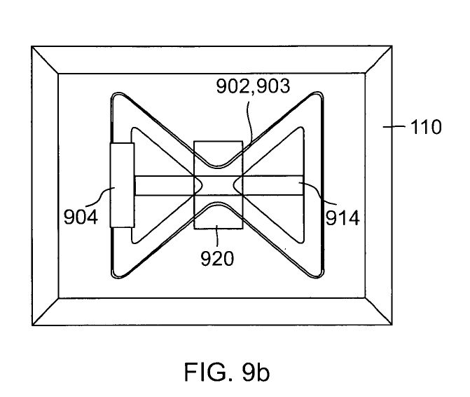

FIGS. 9a and b illustrate another embodiment for the extendable/retractable arm 900, which comprises linking elements or links 902 and 903 having an “X” configuration. Link 902 is coupled to a base 904 which is coupled to the housing 110 via one or more bolts 905 and washers 910, which pass through channels 906 in the base 904 and vertical proximate section 908 of the link 902, to form a pivotal joint between the base and link 902. As illustrated in the figure, section 908 comprises top and bottom segments extending towards one another with a gap in between, wherein the base fits within the gap. A c-clip 924 is positioned at the end of the bolt. Thus, link 902 may swivel with respect to the base. Though the figure illustrates a connection via one bolt inserted from the bottom, it is also possible to insert the bolt from the top, or use two bolts from the top and bottom.

The vertical distal section 912 of link 902 is coupled to the vertical proximate section 913 of link 903 via an alternate link 914. As with section 908, sections 912 and 913 comprise top and bottom segments extending towards one another with a gap in-between, wherein link 914 fits within the gaps. Similarly, the links 902, 903, and 914 are coupled via bolts 905 and washers 910, which fit through channels 916 provided in each linking element, and the bolts are held with a c-clip 924. Again, the bolt may be inserted from the top, instead of the bottom (shown in the figure) or two bolts may be used for each connection.

Next, distal section 918 of link 903 is coupled to a mounting bracket 920 for the screen. As with sections 908, 912, and 913, section 918 comprise top and bottom segments extending towards one another with a gap in-between, wherein an extension 921 of bracket 920 fits within the gap. Similarly, the link and bracket are coupled via bolts 905 and washers 910, engaged through channels 922, and held by c-clip 924. Again, the bolt may be inserted from the top, instead of the bottom (shown in the figure) or two bolts may be used for each connection. It should also be noted that any number of links may be used, depending on the desired length of the arm. Also, as illustrated in FIG. 9b, the device may fold flat into the housing 110.

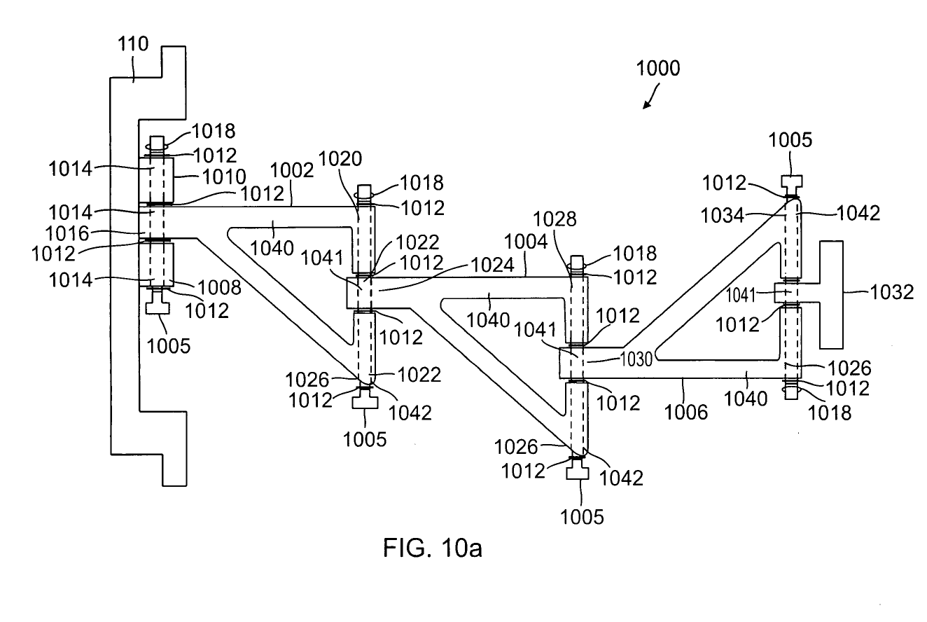

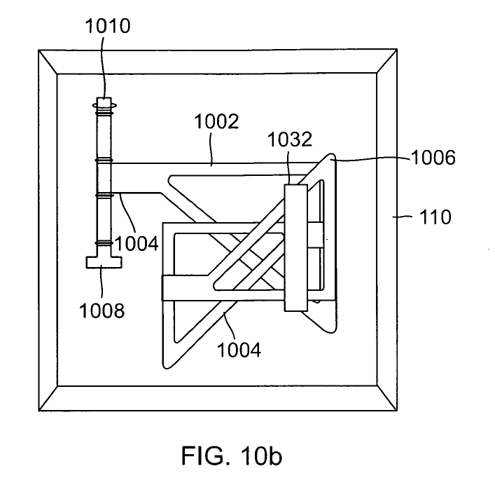

FIGS. 10 a and b illustrates another embodiment for an extendable/retractable arm 1000, which comprises links 1002, 1004, 1006 having triangularly configured portions. Each link comprises a horizontal leg 1040 having a first and second opposite ends, a second vertical leg 1042 having a first end extending from the second end of the first leg, and forming a right angle with the first leg, and a diagonal extending from the opposite second end of the second leg to a point between the first and second ends of said first leg, forming a right triangle. Additionally, the second leg is divided into top and bottom segment, which extend towards each other forming a gap 1041, as shown in the figure. Thus, the first end of the leg 1040 of one link is rotationally coupled to a second link at the gap 1041 formed in the second leg of another link.

In FIG. 10, link 1002 is coupled to base elements 1008, 1010, which are coupled to the housing 110 via a bolt 1005 and washers 1012, which pass through channels 1014 in the base elements and proximate section 1016 of the link 1002, to form a pivotal joint between the base and link 1002. A c-clip 1018 is positioned at the end of the bolt. Thus, link 1002 may swivel with respect to the base elements. Though the figure illustrates a connection via one bolt inserted from the bottom, it is also possible to insert the bolt from the top, or use two bolts from the top and bottom.

The vertical distal section 1020 of link 1002 is directly coupled to link 1004 via a bolt 1005 and washers 1012, which pass through channels 1022 in the section 1020 of the link 1002 and proximate section 1024 in the link 1004, to form a pivotal joint between the links. A c-clip 1018 is positioned at the end of the bolt to hold the assembly in place. Also, it is preferable to provide a flat surface at the triangular pointed end 1026 of each end, to facilitate assembly. An alternate linking element is not needed between links 1002 and 1004, due to the triangular configuration. Again, the bolt may be inserted from the top, instead of the bottom (shown in the figure) or two bolts may be used for each connection.

Next, the distal end 1028 of link 1004, is similarly coupled to proximate end 1030 of link 1006, and a mounting bracket 1032 is similarly coupled to end 1034 of link 1006. It should be noted that any number of links may be used for the arm 1000, and that each of the links may be positioned with the triangular pointed end up or down. Additionally, as illustrated in FIG. 10b, the device may fold flat into the housing 110.

Additionally, the device 100 may be electronically controlled, and may also include remote control for adjusting the position of the screen, in order to avoid glare, change the viewing angle, etc.

While the invention has been illustrated for flat panel display screen, it is contemplated for use with other types of display devices.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the description is illustrative and not meant to be a limitation thereof.

What is claimed is:

1. A support mount device for a display screen comprising:
a) a length adjustable arm having first and second ends, said arm comprising a plurality of interconnected links, each link comprising:
a triangular portion comprising:
i) a first approximately horizontal leg having a first and second opposite ends, said first end of said leg forming said first end of said link,
ii) a second approximately vertical leg having a first end extending from said first leg at said second end of said first leg, and forming a substantially right angle therewith, said second leg forming said second end of said arm, and
iii) a diagonal extending from said second end of said second leg to a point between said first and second ends of said first leg, forming the hypotenuse of said triangle opposite said right angle, wherein said second leg is divided into a first segment extending from said first end of said second leg coupled to said second end of said first leg, and a second segment extending towards said first segment from said second end of said second leg coupled to said diagonal, there being a gap between said first and second segments, and wherein
said first end of said first leg of one link is pivotally connected at said gap to said second leg of another link, to form said arm;
b) a housing mountable to a wall, said housing including:
a central recess comprising:
i) a substantially flat surface having a front and a back side, and an outer perimeter, and
surrounding walls having first and second ends, said surrounding walls extending generally perpendicular from said front side of said flat surface, said surrounding walls joint to said perimeter of said flat surface at said first end of said surrounding walls, and
ii) a frame around said recess, said frame comprising a surface substantially parallel to said flat surface of said recess, and extending from and substantially perpendicular to said surrounding walls of said recess, said flat surface including an opening or cut out for receiving wires of the display screen;
c) a base coupled to said recess at said front side of said flat surface of said recess, said arm being coupled to said base at one end of said arm, wherein said arm is extendable and retractable relative to said housing, and can further be compacted into said housing; and
d) a mounting element coupled to said arm at an end opposite the end mounted to the base, wherein the screen can be mounted to the mounting element.

2. A support mount device for a display screen comprising:
a) a length adjustable arm having first and second ends, said arm comprising a plurality of interconnected links, said links comprising:
i) at least two X link, said link including:
first and second diagonals intersecting at a central point and forming an X configuration, and having top and bottom proximate ends and top and bottom distal ends,
top and bottom vertical segments extending from said ends, wherein
a first set of top and bottom segments extend downwards and upwards, respectively, from said top and bottom proximate ends, there being a gap formed between said segments, said gap forming a proximate linking end of said X link, and
a second set of top and bottom segments extend downwards and upwards, respectively, from said top and bottom distal ends, there being a gap formed between said segments, said gap forming a distal linking end of said X link,
ii) at least one bar link, pivotally connected between two X links, said bar link being connected between two adjacent X links, at the distal linking end of one link and the proximate linking end of another link;
b) a housing mountable to a wall, said housing including:
a central recess comprising:
i) a substantially flat surface having a front and a back side, and an outer perimeter, and
surrounding walls having first and second ends, said surrounding walls extending generally perpendicular from said front side of said flat surface, said surrounding walls joint to said perimeter of said flat surface at said first end of said surrounding walls, and
ii) a frame around said recess, said frame comprising a surface substantially parallel to said flat surface of said recess, and extending from and substantially perpendicular to said surrounding walls of said recess, said flat surface including an opening or cut out for receiving wires of the display screen;
c) a base coupled to said recess at said front side of said flat surface of said recess, said arm being coupled to said base at a proximate linking end forming said first end of said arm, wherein said arm is extendable and retractable relative to said housing, and can further be compacted into said housing; and
d) a mounting element coupled to said arm at a distal linking end forming said second end of said arm, wherein the screen can be mounted to the mounting element.

3. A support mount device for a display screen comprising:
a) a length adjustable arm having first and second ends,
b) a housing mountable to a wall, said housing including:
a central recess comprising:
i) a substantially flat surface having a front and a back side, and an outer perimeter, and
surrounding walls having first and second ends, said surrounding walls extending generally perpendicular from said front side of said flat surface, said surrounding walls joint to said perimeter of said flat surface at said first end of said surrounding walls, and
ii) a frame around said recess, said frame comprising a surface substantially parallel to said flat surface of said recess, and extending from and substantially perpendicular to said surrounding walls of said recess, said flat surface including an opening or cut out for receiving wires of the display screen, wherein
said arm is coupled to said front side of said flat surface of said recess at or near said first end of said arm, said arm being extendable and retractable relative to said housing, said arm further being compactable into said housing; and
c) a mounting element coupled to said arm at said second end of said arm, wherein the screen can be mounted to the mounting element.

4. The device of claim 3, said arm including a series of telescopically engaged elements which are telescopically extendable and retractable relative to said housing.

5. The device of claim 3 said arm comprising a series of rotationally coupled connecting links.

6. The device of claim 3, said flat surface of said flat surface of said frame including a hole or cut out for receiving wires of the device.

7. The device of claim 3 further comprising an electronic position control element for electronically adjusting the position of the screen.

8. The device of claim 7, said electronic control element allowing for remotely adjusting the position of the screen.

9. The device of claim 3 wherein the display screen fits within said recess.

10. The device of claim 3, said recess and display screen having surface areas, wherein the surface area of the recess is smaller than the surface area of the display screen.

11. The device of claim 3, said housing being coupled to a recess in the wall which conforms to the recess of said housing.

12. The device of claim 3, wherein said mounting element allows for movement of the screen relative to said arm, said motion comprising swivel, pivotal, up and down, side-to-side, or combinations thereof.

13. The device of claim 3, said arm extending through said recess into a bore in the wall.

14. The device of claim 3, said recess including a recessed channel which extends into the wall when said device is mounted to the wall, said arm extending through said channel.

15. A method for mounting a display screen, said method comprising:
providing a length adjustable arm having first and second ends;
providing a recess within a wall, said recessed sized to contain said arm, said screen, or both,
coupling said arm to said recess of said wall at or near a first end of said arm; and
mounting said display screen to a second end of said arm.

16. The method of claim 15, further comprising:
providing a housing for said arm, said housing comprising:
i) a central recess conforming to said recess of said wall, said recess comprising:
a substantially flat surface having a front and a back side, and an outer perimeter, and
surrounding walls having first and second ends, said surrounding walls extending generally perpendicular from said front side of said flat surface, said surrounding walls joint to said perimeter of said flat surface at said first end of said surrounding walls, and
ii) a frame around said recess, said frame comprising a surface substantially parallel to said flat surface of said recess, and extending from and substantially perpendicular to said surrounding walls of said recess, said flat surface including an opening or cut out for receiving wires of the display screen, wherein
said arm is coupled to said front side of said flat surface of said recess at or near said first end of said arm, said arm being extendable and retractable relative to said housing, said arm also being compactable into said housing; and
connecting said housing to said wall, by overlapping said recess of said housing to said recess of said wall, and affixing said outer frame to a section of said wall surrounding said recess.

17. The method of claim 16, said arm including a series of telescopically engaged elements which are telescopically extendable and retractable relative to said housing.

18. The method of claim 16 said arm comprising a plurality of interconnected links, each link comprising:
a triangular portion comprising:
i) a first approximately horizontal leg having a first and second opposite ends, said first end of said leg forming said first end of said link,
ii) a second approximately vertical leg having a first end extending from said first leg at said second end of said first leg, and forming a substantially right angle therewith, said second leg forming said second end of said arm, and
iii) a diagonal extending from said second end of said second leg to a point between said first and second ends of said first leg, forming the hypotenuse of said triangle opposite said right angle, wherein
said second leg is divided into a first segment extending from said first end of said second leg coupled to said second end of said first leg, and a second segment extending towards said first segment from said second end of said second leg coupled to said diagonal, there being a gap between said first and second segments, and wherein
said first end of said first leg of one link is pivotally connected at said gap to said second leg of another link, to form said arm.

19. The method of claim 16, said arm comprising a plurality of interconnected links, said links comprising:
i) at least two X link, said link including:
first and second diagonals intersecting at a central point and forming an X configuration, and having top and bottom proximate ends and top and bottom distal ends,
top and bottom vertical segments extending from said ends, wherein
a first set of top and bottom segments extend downwards and upwards, respectively, from said top and bottom proximate ends, there being a gap formed between said segments, said gap forming a proximate linking end of said X link, and
a second set of top and bottom segments extend downwards and upwards, respectively, from said top and bottom distal ends, there being a gap formed between said segments, said gap forming a distal linking end of said X link,
ii) at least one bar link, pivotally connected between two X links, said bar link being connected between two adjacent X links, at the distal linking end of one link and the proximate linking end of another link;

20. The method of claim 16, said second end of said arm including a mounting element for mounting said screen, wherein said mounting element allows for movement of the screen relative to said arm, said movement comprising swivel, pivotal, up and down, side-to-side, or combinations thereof.
